(19) United States
(12) Patent Application Publication
(10) Pub. No.: US 2006/0148984 A1
(43) Pub. Date: Jul. 6, 2006

(54) Use of compositions based on impact-resistant modified polyalkylene terephtalate/polycarbonate blends for producinng molded bodies

(76) Inventors: Peter Persigehl, Ratingen (DE); Thomas Braig, Dusseldorf (DE); Alexander Karbach, Krefeld (DE); Matthias Voetz, Koln (DE); Friedemann Paul, Gladbach (DE); Doris Drechsler, Leverkusen (DE); Jorg Tillack, Gladbach (DE)

Correspondence Address: BAYER MATERIAL SCIENCE LLC, 100 BAYER ROAD, PITTSBURGH, PA, 15205, US

(21) Appl. No.: 10/545,839

(22) PCT Filed: Feb. 12, 2004
(86) PCT No.: PCT/EP04/01294

§ 371 Date: Feb. 2, 2006

(30) Foreign Application Priority Data
Feb. 21, 2003 (DE) 103 07 685.9
Mar. 5, 2003 (DE) 103 09 452.0

(51) Int. Cl. C08L 51/00

(52) U.S. Cl. 525/67

(57) ABSTRACT

A molded article lacquered with a water base lacquer is disclosed. The thermoplastically molded article contains A) 4 to 80 parts by weight (pbw) of a first polyalkylene terephthalate, B) 4 to 80 pbw of a second polyalkylene terephthalate having an alkylene chain length different from said first polvalkylene terephthalate, C) 10 to 90 pbw of aromatic polycarbonate, D) 1 to 30 pbw of at least one member selected from the group consisting of elastomeric polymer and graft copolymer, E) 0.1 to 20 pbw of at least one member selected from the group consisting of conventional additive and processing aid, wherein the total pbw of (A) through (E) equals 100 pbw, and optionally F) 0 to 60 pbw of a particulate mineral filler. The inventive article is suitable for making vehicular external parts.

The present invention relates to the use of compositions based on impact-modified polyalkylene terephthalate/polycarbonate blends in the production of semi-finished products and mouldings.

Impact-modified moulding compositions comprising semi-crystalline polyesters, amorphous polycarbonates and their use as substrates for lacquers are known. Such moulding compositions are used, for example, in the automotive sector for mouldings such as bumpers, wings, radiator grills, sun visors, rear visors, sills, spoilers, door handles, tank covers, cladding, horizontal components such as bonnets or roof elements, door modules or the like. Requirements for use in motor vehicle applications are, inter alia, high dimensional stability under heat, high flowability in the molten state, high impact strength even at low temperatures, and good lacquer adhesion.

Lacquering of these substrates can be carried out using a single-layer, two-layer or multi-layer lacquer system. Lacquer structures may comprise inter alia the following layers: adhesive primer, conductive primer, primer surfacer, base lacquers, clear lacquers and/or finishing lacquers.

Lacquering has for a long time been carried out using lacquer systems which are based on organic solvents and are referred to hereinbelow as organic lacquer systems, so that substrates based on impact-modified polyalkylene terephthalate/polycarbonate blends have been optimised for maximum adhesion of the organic lacquer systems. State of the art here are especially compositions based on impact-modified polybutylene terephthalate/polycarbonate blends which, as well as exhibiting very good lacquer adhesion, also have high dimensional stability under heat and low-temperature impact strength. This is described, for example, in DE 3118526 and WO 0234833.

For environmental reasons, solvent-containing lacquers are nowadays increasingly being replaced by water-based lacquers. In a so-called aqueous lacquer (“water-based lacquer”), a considerable proportion of the solvents is replaced by water. If the layer applied directly to the substrate is changed from a solvent-containing layer to an aqueous layer, inadequate lacquer adhesion is frequently obtained in the case of the substrates based on impact-modified polyalkylene terephthalate/polycarbonate blends which have been optimised for the use of solvent-containing lacquer systems.

The object of this invention was, therefore, to optimise the substrate based on impact-modified polyalkylene terephthalate/polycarbonate blends for the adhesion of hydro-based lacquers, whereby the other key properties of this class of material, such as, for example, dimensional stability under heat, low-temperature strength, rigidity and flowability, are retained.

Surprisingly, it has now been found that, in the case of compositions based on impact-modified blends of polycarbonate and polyalkylene terephthalates, the adhesion of hydro-based lacquers can be increased, while the other mentioned key properties are retained, if the polyalkylene terephthalate component comprises a mixture of at least two different polyalkylene terephthalates having different alkylene chain lengths, preferably at least polybutylene terephthalate and polyethylene terephthalate. The moulding compositions according to the invention are further distinguished by high dimensional stability under heat, high flowability in the molten state, high rigidity, high dimensional stability and high low-temperature strength.

The invention relates to the use of compositions comprising
A) from 4 to 80 parts by weight, preferably from 10 to 60 parts by weight, particularly preferably from 12 to 40 parts by weight, especially from 15 to 30 parts by weight, of at least one polyalkylene terephthalate, preferably of at least one polybutylene terephthalate,
B) from 4 to 80 parts by weight, preferably from 6 to 60 parts by weight, particularly preferably from 8 to 40 parts by weight, especially from 10 to 30 parts by weight, of at least one polyalkylene terephthalate having an alkylene chain length different from component A, preferably of at least one polyethylene terephthalate,
C) from 10 to 90 parts by weight, preferably from 20 to 80 parts by weight, particularly preferably from 25 to 60 parts by weight, especially from 35 to 55 parts by weight, of at least one aromatic polycarbonate,
D) from 1 to 30 parts by weight, preferably from 3 to 25 parts by weight, particularly preferably from 6 to 20 parts by weight, especially from 8 to 16 parts by weight, of at least one elastomeric polymer or graft copolymer,
E) from 0.1 to 20 parts by weight, preferably from 0.15 to 15 parts by weight, particularly preferably from 0.2 to 10 parts by weight, of conventional additives and processing aids,
   which together give 100 parts by weight, optionally additionally comprising
F) from 0 to 60 parts by weight, preferably from 2 to 45 parts by weight, particularly preferably from 4 to 30 parts by weight, of at least one particulate mineral filler,
   in the production of lacquered mouldings, wherein moulded bodies are produced from A)-F) and are lacquered with hydro lacquers, wherein in the case of multi-layer lacquer systems having different solvents, at least the solvent of the first, lowermost lacquer layer must be water-based.

According to the invention, the compositions comprise as component A one polyalkylene terephthalate or a mixture of two or more different polyalkylene terephthalates. Polyalkylene terephthalates within the scope of the invention are polyalkylene terephthalates which are derived from terephthalic acid (or reactive derivatives thereof) and alkanediols, for example based on propylene glycol or butanediol. According to the invention there is preferably used as component A polybutylene terephthalate and/or polytrimethylene terephthalate, most preferably polybutylene terephthalate.

Polyalkylene terephthalates within the scope of the invention are reaction products of aromatic dicarboxylic acids or reactive derivatives thereof (e.g. dimethyl esters or anhydrides) and aliphatic, cycloaliphatic or araliphatic diols, and mixtures of these reaction products.

Preferred polyalkylene terephthalates can be prepared from terephthalic acid (or reactive derivatives thereof) and aliphatic or cycloaliphatic diols having from 2 to 10 carbon atoms by known methods (Kunststoff-Handbuch, Vol. VIII, p. 695 ff, Karl-Hanser-Verlag, Munich, 1973).

Preferred polyalkylene terephthalates contain at least 80 mol. %, preferably 90 mol. %, based on the dicarboxylic acid, of terephthalic acid radicals and at least 80 mol. %, preferably at least 90 mol. %, based on the diol component, of ethylene glycol and/or 1,3-propanediol and/or 1,4-butanediol radicals.

The preferred polyalkylene terephthalates can contain, in addition to terephthalic acid radicals, up to 20 mol. % of radicals of other aromatic dicarboxylic acids having from 8 to 14 carbon atoms or of aliphatic dicarboxylic acids having from 4 to 12 carbon atoms, such as radicals of phthalic acid, isophthalic acid, naphthalene-2,6-dicarboxylic acid, 4,4′-diphenyldicarboxylic acid, succinic acid, adipic acid, sebacic acid, azelaic acid, cyclohexanediacetic acid, cyclohexanedicarboxylic acid.

The preferred polyalkylene terephthalates can contain, in addition to ethylene or 1,3-propanediol or 1,4-butanediol glycol radicals, up to 20 mol. % of other aliphatic diols having from 3 to 12 carbon atoms or of cycloaliphatic diols having from 6 to 21 carbon atoms, for example radicals of 1,3-propanediol, 2-ethyl-1,3-propanediol, neopentyl glycol, 1,5-pentanediol, 1,6-hexanediol, 1,4-cyclohexanedimethanol, 3-methyl-2,4-pentanediol, 2-methyl-2,4-pentanediol, 2,2,4-trimethyl-1,3-pentanediol and -1,6,2-ethyl-1,3-hexanediol, 2,2-diethyl-1,3-propanediol, 2,5-hexanediol, 1,4-di-(β-hydroxyethoxy)-benzene, 2,2-bis-(4-hydroxycyclohexyl)-propane, 2,4-dihydroxy-1,1,3,3-tetramethyl-cyclobutane, 2,2-bis-(3-β-hydroxyethoxyphenyl)-propane and 2,2-bis-(4-hydroxypropoxyphenyl)-propane (DE-A 24 07 674, 24 07 776, 27 15 932).

The polyalkylene terephthalates can be branched by the incorporation of relatively small amounts of tri- or tetra-hydric alcohols or of tri- or tetra-basic carboxylic acids, as are described, for example, in DE-A 19 00 270 and U.S. Pat. No. 3,692,744. Examples of preferred branching agents are trimesic acid, trimellitic acid, trimethylol-ethane and -propane and pentaerythritol.

It is advisable to use not more than 1 mol. % of the branching agent, based on the acid component.

Particular preference is given to polyalkylene terephthalates that have been prepared solely from terephthalic acid and reactive derivatives thereof (e.g. dialkyl esters thereof) and ethylene glycol and/or 1,3-propanediol and/or 1,4-butanediol (polyethylene and polybutylene terephthalate), and mixtures of these polyalkylene terephthalates.

Preferred polyalkylene terephthalates are also copolyesters which are prepared from at least two of the above-mentioned acid components and/or from at least two of the above-mentioned alcohol components, and particularly preferred copolyesters are poly-(ethylene glycol/1,4-butanediol) terephthalates.

The polyalkylene terephthalates generally have an intrinsic viscosity of approximately from 0.4 to 1.5 dl/g, preferably from 0.5 to 1.3 dl/g, in each case measured in phenol/o-dichlorobenzene (1:1 parts by weight) at 25° C.

Preferably, the polyesters prepared according to the invention can also be used in admixture with other polyesters and/or further polymers. Particular preference is given to the use of mixtures of polyalkylene terephthalates with other polyesters.

Conventional additives, such as, for example, mould-release agents, stabilisers and/or flow agents, may be mixed with the polyesters in the molten state or applied to the surface thereof.

According to the invention, the compositions comprise as component B at least one polyalkylene terephthalate corresponding to component A that differs from component A in the length of the alkylene chain of the alkanediol used.

There is preferably used as component B at least one polyethylene terephthalate, very preferably when at least one polybutylene terephthalate is used as component A.

Polyethylene terephthalates within the scope of the invention are polyalkylene terephthalates that are derived from terephthalic acid (or its reactive derivatives) and alkanediols based on ethylene glycol.

Preferred polyethylene terephthalates (also abbreviated to PET hereinbelow) can be prepared from terephthalic acid (or its reactive derivatives) and aliphatic or cycloaliphatic diols having an ethylene glycol unit by known methods (Kunststoff-Handbuch, Vol. VIII, p. 695 ff, Karl-Hanser-Verlag, Munich, 1973).

Preferred polyethylene terephthalates contain at least 80 mol. %, preferably 90 mol. %, based on the dicarboxylic acid, of terephthalic acid radicals and at least 80 mol. %, preferably at least 90 mol. %, based on the diol component, of ethylene glycol radicals.

The preferred polyethylene terephthalates can contain, in addition to terephthalic acid radicals, up to 20 mol. % of radicals of other aromatic dicarboxylic acids having from 8 to 14 carbon atoms or of aliphatic dicarboxylic acids having from 4 to 12 carbon atoms, preferably phthalic acid, isophthalic acid, naphthalene-2,6-dicarboxylic acid, 4,4′-diphenyldicarboxylic acid, succinic acid, adipic acid, sebacic acid, azelaic acid, cyclohexanediacetic acid.

The preferred polyethylene terephthalates can contain, in addition to ethylene glycol, up to 20 mol. % of other aliphatic diols having from 3 to 12 carbon atoms or of cycloaliphatic diols having from 6 to 21 carbon atoms, for example 1,3-propanediol, 2-ethyl-1,3-propanediol, neopentyl glycol, 1,5-pentanediol, 1,6-hexanediol, 1,4-cyclohexanedimethanol, 3-methyl-2,4-pentanediol, 2-methyl-2,4-pentanediol, 2,2,4-trimethyl-1,3-pentanediol and -1,6,2-ethyl-1,3-hexanediol, 2,2-diethyl-1,3-propanediol, 2,5-hexanediol, 1,4-di-(β-hydroxyethoxy)-benzene, 2,2-bis-(4-hydroxycyclohexyl)-propane, 2,4-dihydroxy-1,1,3,3-tetramethyl-cyclobutane, 2,2-bis-(3-β-hydroxyethoxyphenyl)-propane and 2,2-bis-(4-hydroxypropoxyphenyl)-propane (DE-A 24 07 674, 24 07 776, 27 15 932). Polyethylene terephthalates can further contain also up to 20 mol. % of ether or polyether structures.

The polyethylene terephthalates can be branched by the incorporation of relatively small amounts of tri- or tetra-hydric alcohols or of tri- or tetra-basic carboxylic acids, as are described, for example, in DE-A 19 00 270 and U.S. Pat. No. 3,692,744. Examples of preferred branching agents are trimesic acid, trimellitic acid, trimethylol-ethane and -propane and pentaerythritol. It is advisable to use not more than 1 mol. % of the branching agent, based on the acid component.

Preferred polyethylene terephthalates are also copolyesters which are prepared from at least two acid components and/or from at least two alcohol components, and particularly preferred copolyesters are poly-(ethylene glycol/1,4-butanediol) terephthalates.

Particular preference is given to polyethylene terephthalates that have been prepared solely from terephthalic acid and reactive derivatives thereof (e.g. dialkyl esters thereof) and ethylene glycol.

The polyethylene terephthalates generally have an intrinsic viscosity of approximately from 0.3 to 1.5 dl/g, preferably from 0.4 to 1.3 dl/g, especially preferably from 0.5 to 0.8 dl/g, in each case measured in phenol/o-dichlorobenzene (1:1 parts by weight) at 25° C.

Particular preference is given to rapidly crystallising polyethylene terephthalates, that is to say polyethylene terephthalates that, according to the DSC method for isothermal crystallisation, exhibit crystallisation times at 215° C. generally of less than 15 minutes, preferably of less than 10 minutes and particularly preferably of less than 5 minutes.

Rapid crystallisation of the polyethylene terephthalates according to the invention is preferably achieved by addition of crystallisation agents to the polyethylene terephthalate during or following its preparation, for example by mixing them into the polyethylene terephthalate melt. As crystallisation agents there are preferably used metal salts of organic carboxylic acids, such as, for example, alkali or alkaline earth metal salts of benzoic acid or substituted benzoic acid.

According to the invention, the compositions according to the invention comprise as component C a polycarbonate or a mixture of polycarbonates.

Preferred polycarbonates are homopolycarbonates and copolycarbonates based on bisphenols of the general formula (I)
HO-Z-OH (I)
wherein Z is a divalent organic radical having from 6 to 30 carbon atoms which contains one or more aromatic groups.

Preference is given to bisphenols of formula (Ia) 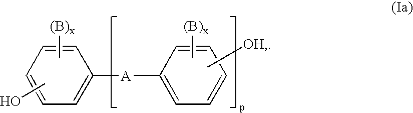
wherein
A represents a single bond, C₁-C₅-alkylene, C₂-C₅-alkylidene, C₅-C₆-cyclo-alkylidene, —O—, —SO—, —CO—, —S—, —SO₂—, C₆-C₁₂-arylene, to which there may be condensed further aromatic rings optionally containing hetero atoms,
   or a radical of formula (II) or (III) 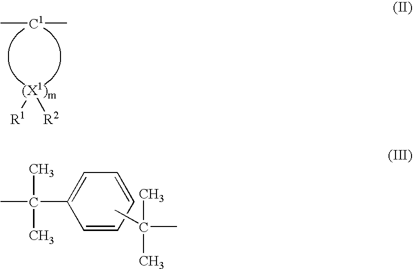
each of the substituents B represents C₁-C₁₂-alkyl, preferably methyl, halogen, preferably chlorine and/or bromine,
the substituents x are each independently of the other 0, 1 or 2,
p represents 1 or 0, and
R¹ and R² can be selected individually for each X¹ and are each independently of the other hydrogen or C₁-C₆-alkyl, preferably hydrogen, methyl or ethyl,
X¹ represents carbon, and
m represents an integer from 4 to 7, preferably 4 or 5, with the proviso that on at least one atom X¹, R¹ and R² are simultaneously alkyl.

Examples of bisphenols according to the general formula (1) are bisphenols belonging to the following groups: dihydroxydiphenyls, bis-(hydroxyphenyl)-alkanes, bis-(hydroxyphenyl)-cycloalkanes, indane bisphenols, bis-(hydroxyphenyl) sulfides, bis-(hydroxyphenyl) ethers, bis-(hydroxyphenyl) ketones, bis-(hydroxyphenyl)sulfones, bis-(hydroxyphenyl) sulfoxides and α,α′-bis-(hydroxyphenyl)-diisopropylbenzenes.

Examples of bisphenols according to the general formula (I) are also derivatives of the mentioned bisphenols which are obtainable, for example, by alkylation or halogenation on the aromatic rings of the mentioned bisphenols.

Examples of bisphenols according to the general formula (I) are in particular the following compounds: hydroquinone, resorcinol, 4,4′-dihydroxydiphenyl, bis-(4-hydroxyphenyl) sulfide, bis-(4-hydroxyphenyl)sulfone, bis-(3,5-dimethyl-4-hydroxy-phenyl)-methane, bis-(3,5-dimethyl-4-hydroxyphenyl)-sulfone, 1,1-bis-(3,5-dimethyl-4-hydroxyphenyl)-p/m-diisopropylbenzene, 1,1-bis-(4-hydroxyphenyl)-1-phenylethane, 1,1-bis-(3,5-dimethyl-4-hydroxyphenyl)-cyclohexane, 1,1-bis-(4-hydroxyphenyl)-3-methylcyclohexane, 1,1-bis-(4-hydroxyphenyl)-3,3-dimethyl-cyclohexane, 1,1-bis-(4-hydroxyphenyl)-4-methylcyclohexane, 1,1-bis-(4-hydroxy-phenyl)-cyclohexane, 1,1-bis-(4-hydroxyphenyl)-3,3,5-trimethylcyclohexane, 2,2-bis-(3,5-dichloro-4-hydroxyphenyl)-propane, 2,2-bis-(3-methyl-4-hydroxyphenyl)-propane, 2,2-bis-(3,5-dimethyl-4-hydroxyphenyl)-propane, 2,2-bis-(4-hydroxy-phenyl)-propane (i.e. bisphenol A), 2,2-bis-(3-chloro-4-hydroxyphenyl)-propane, 2,2-bis-(3,5-dibromo-4-hydroxyphenyl)-propane, 2,4-bis-(4-hydroxyphenyl)-2-methylbutane, 2,4-bis-(3,5-dimethyl-4-hydroxyphenyl)-2-methylbutane, α,α′-bis-(4-hydroxyphenyl)-o-diisopropylbenzene, α,α′-bis-(4-hydroxyphenyl)-m-diisopropyl-benzene (i.e. bisphenol M), α,α′-bis-(4-hydroxyphenyl)-p-diisopropylbenzene and indane bisphenol.

Particularly preferred polycarbonates are the homopolycarbonate based on bisphenol A, the homopolycarbonate based on 1,1-bis-(4-hydroxyphenyl)-3,3,5-trimethylcyclohexane and the copolycarbonates based on the two monomers bisphenol A and 1,1-bis-(4-hydroxyphenyl)-3,3,5-trimethylcyclohexane.

The described bisphenols according to the general formula (I) can be prepared by known processes, for example from the corresponding phenols and ketones.

The mentioned bisphenols and processes for their preparation are described, for example, in the monograph H. Schnell, “Chemistry and Physics of Polycarbonates”, Polymer Reviews, Volume 9, p. 77-98, Interscience Publishers, New York, London, Sidney, 1964 and in U.S. Pat. No. 3,028,635, in U.S. Pat. No. 3,062,781, in U.S. Pat. No. 2,999,835, in U.S. Pat. No. 3,148,172, in U.S. Pat. No. 2,991,273, in U.S. Pat. No. 3,271,367, in U.S. Pat. No. 4,982,014, in U.S. Pat. No. 2,999,846, in DE-A 1 570 703, in DE-A 2 063 050, in DE-A 2 036 052, in DE-A 2 211 956, in DE-A 3 832 396, and in FR-A 1 561 518 and also in the Japanese Offenlegungsschriften having the application numbers JP-A 62039 1986, JP-A 62040 1986 and JP-A 105550 1986.

1,1-Bis-(4-hydroxyphenyl)-3,3,5-trimethylcyclohexane and its preparation are described, for example, in U.S. Pat. No. 4,982,014.

Indane bisphenols and their preparation are described, for example, in U.S. Pat, No. 3,288,864, in JP-A 60 035 150 and in U.S. Pat. No. 4,334,106. Indane bisphenols can be prepared, for example, from isopropenylphenol or its derivatives or from dimers of isopropenylphenol or its derivatives in the presence of a Friedel-Crafts catalyst in organic solvents.

Polycarbonates can be prepared by known processes. Suitable processes for the preparation of polycarbonates are, for example, preparation from bisphenols with phosgene by the interfacial process or from bisphenols with phosgene by the process in homogeneous phase, the so-called pyridine process, or from bisphenols with carbonic acid esters by the melt transesterification process. These preparation processes are described, for example, in H. Schnell, “Chemistry and Physics of Polycarbonates”, Polymer Reviews, Volume 9, p. 31-76, Interscience Publishers, New York, London, Sidney, 1964. The mentioned preparation processes are also described in D. Freitag, U. Grigo, P. R. Müller, H. Nouvertne, “Polycarbonates” in Encyclopedia of Polymer Science and Engineering, Volume 11, Second Edition, 1988, pages 648 to 718 and in U. Grigo, K. Kircher and P. R. Müller “Polycarbonate” in Becker, Braun, Kunststoff-Handbuch, Volume 3/1, Polycarbonate, Polyacetale, Polyester, Celluloseester, Carl Hanser Verlag Munich, Vienna 1992, pages 117 to 299 and in D. C. Prevorsek, B. T. Debona and Y. Kesten, Corporate Research Center, Allied Chemical Corporation, Morristown, N.J. 07960, “Synthesis of Poly(estercarbonate) Copolymers” in Journal of Polymer Science, Polymer Chemistry Edition, Vol. 19, 75-90 (1980).

The melt transesterification process is described in particular, for example, in H. Schnell, “Chemistry and Physics of Polycarbonates”, Polymer Reviews, Volume 9, p. 44 to 51, Interscience Publishers, New York, London, Sidney, 1964 and in DE-A 1 031512.

In the preparation of polycarbonate, raw materials and auxiliary substances having a low degree of impurities are preferably used. In the case of preparation by the melt transesterification process in particular, the bisphenols and carbonic acid derivatives used should be as free as possible of alkali ions and alkaline earth ions. Such pure raw materials are obtainable, for example, by recrystallising, washing or distilling the carbonic acid derivatives, for example carbonic acid esters, and the bisphenols.

The polycarbonates that are suitable according to the invention have a weight-average molar mass (\overline{M}_{w}), which can be determined, for example, by ultracentrifugation or scattered light measurement, of preferably from 10,000 to 200,000 g/mol. Particularly preferably, they have a weight-average molar mass of from 12,000 to 80,000 g/mol., especially preferably from 20,000 to 35,000 g/mol.

The mean molar mass of the polycarbonates according to the invention can be adjusted, for example, in known manner by an appropriate amount of chain terminators. The chain terminators can be used individually or in the form of a mixture of different chain terminators.

Suitable chain terminators are both monophenols and monocarboxylic acids. Suitable monophenols are, for example, phenol, p-chlorophenol, p-tert.-butylphenol, cumylphenol or 2,4,6-tribromophenol, as well as long-chained alkylphenols, such as, for example, 4-(1,1,3,3-tetramethylbutyl)-phenol, or monoalkylphenols or dialkylphenols having a total of from 8 to 20 carbon atoms in the alkyl substituents, such as, for example, 3,5-di-tert.-butylphenol, p-tert.-octylphenol, p-dodecylphenol, 2-(3,5-dimethylheptyl)-phenol or 4-(3,5-dimethylheptyl)-phenol. Suitable monocarboxylic acids are benzoic acid, alkylbenzoic acids and halobenzoic acids.

Preferred chain terminators are phenol, p-tert.-butylphenol, 4-(1,1,3,3-tetramethyl-butyl)-phenol and cumylphenol.

The amount of chain terminators is preferably from 0.25 to 10 mol. %, based on the sum of the bisphenols used.

The polycarbonates that are suitable according to the invention may be branched in a known manner, preferably by the incorporation of branching agents having a functionality of three or more. Suitable branching agents are, for example, those having three or more than three phenolic groups or those having three or more than three carboxylic acid groups.

Suitable branching agents are, for example, phloroglucinol, 4,6-dimethyl-2,4,6-tri-(4-hydroxyphenyl)-2-heptene, 4,6-dimethyl-2,4,6-tri-(4-hydroxyphenyl)-heptane, 1,3,5-tri-(4-hydroxyphenyl)-benzene, 1,1,1-tris-(4-hydroxyphenyl)-ethane, tri-(4-hydroxyphenyl)-phenylmethane, 2,2-bis-[4,4-bis-(4-hydroxyphenyl)-cyclohexyl]propane, 2,4-bis-(4-hydroxyphenyl-isopropyl)-phenol, 2,6-bis-(2-hydroxy-5′-methyl-benzyl)-4-methylphenol, 2-(4-hydroxyphenyl)-2-(2,4-dihydroxyphenyl)-propane, hexa-(4-(4-hydroxyphenyl-isopropyl)-phenyl)-terephthalic acid ester, tetra-(4-hydroxyphenyl)-methane, tetra-(4-(4-hydroxyphenyl-isopropyl)-phenoxy)-methane and 1,4-bis-(4′,4″-dihydroxytriphenyl)-methylbenzene, as well as 2,4-dihydroxy-benzoic acid, trimesic acid, cyanuric chloride, 3,3-bis-(3-methyl-4-hydroxyphenyl)-2-oxo-2,3-dihydroindole, trimesic acid trichloride and α,α′,α″-tris-(4-hydroxyphenol)-1,3,5-triisopropylbenzene.

Preferred branching agents are 1,1,1-tris-(4-hydroxyphenyl)-ethane and 3,3-bis-(3-methyl-4-hydroxyphenyl)-2-oxo-2,3-dihydroindole.

The amount of the branching agents that are optionally to be used is preferably from 0.05 mol. % to 2 mol. %, based on moles of bisphenols used.

In the case of the preparation of the polycarbonate by the interfacial process, for example, the branching agents can be placed in a reaction vessel with the bisphenols and the chain terminators in the aqueous alkaline phase, or may be added in the form of a solution in an organic solvent together with the carbonic acid derivatives. In the case of the transesterification process, the branching agents are preferably added together with the dihydroxy aromatic compounds or bisphenols.

Catalysts that are preferably to be used in the preparation of polycarbonate by the melt transesterification process are the ammonium salts and phosphonium salts known in the literature (see, for example, U.S. Pat. No. 3,442,864, JP-A-14742/72, U.S. Pat. No. 5,399,659 and DE-A 19 539 290).

It is also possible to use copolycarbonates. Copolycarbonates within the scope of the invention are especially polydiorganosiloxane-polycarbonate block copolymers whose weight-average molar mass (\overline{M}_{w}) is preferably from 10,000 to 200,000 g/mol., particularly preferably from 20,000 to 80,000 g/mol. (determined by gel chromatography after previous calibration by light scattering measurement or ultracentrifugation). The content of aromatic carbonate structural units in the polydiorganosiloxane-polycarbonate block copolymers is preferably from 75 to 97.5 wt. %, particularly preferably from 85 to 97 wt. %. The content of polydiorganosiloxane structural units in the polydiorganosiloxane-polycarbonate block copolymers is preferably from 25 to 2.5 wt. %, particularly preferably from 15 to 3 wt. %. The polydiorganosiloxane-polycarbonate block copolymers can be prepared, for example, starting from polydiorganosiloxanes containing α,ω-bishydroxyaryloxy end groups and having a mean degree of polymerisation of preferably Pₙ=from 5 to 100, particularly preferably Pₙ=from 20 to 80.

It is possible for conventional additives, such as, for example, mould-release agents, to be mixed with the polycarbonates in the molten state or to be applied to the surface thereof. The polycarbonates used preferably already contain mould-release agents prior to compounding with the other components of the moulding compositions according to the invention.

According to the invention, the compositions comprise as component D) one elastomeric polymer, or a mixture of two or more different elastomeric polymers, having a glass transition temperature below −5° C., preferably below −15° C., more preferably below −30° C., most preferably below −50° C., which are often also referred to as impact modifiers, elastomers or rubbers.

Component D) according to the invention generally comprises copolymers, preferably graft copolymers, of at least two, preferably three, of the following monomers: styrene, acrylonitrile, butadiene, acrylic or methacrylic acid esters of alcohols having from 1 to 18 carbon atoms as alcohol component, vinyl acetate, ethylene, propylene, 1,3-butadiene, isobutene, isoprene and/or chloroprene. Such polymers of component D) are described, for example, in “Methoden der Organischen Chemie” (Houben-Weyl), Vol. 14/1, Georg Thieme-Verlag, Stuttgart 1961, p. 392-406 and in C.B. Bucknall, “Toughened Plastics”, Appl. Science Publishers, London 1977. In the case of graft copolymers, at least one outer shell is grafted onto a core.

Graft copolymers preferably used as component D) are obtained, for example, by graft reaction of styrene, acrylonitrile and/or methyl methacrylate onto a graft base of 1,3-butadiene, isoprene, n-butyl acrylate, styrene and/or 2-ethylhexyl acrylate, more preferably by graft reaction of acrylonitrile, styrene and/or methyl methacrylate onto a graft base of 1,3-butadiene, isoprene, n-butyl acrylate, styrene and/or 2-ethylhexyl acrylate.

Particular preference is given according to the invention to graft copolymers in which methyl methacrylate or a mixture of methyl methacrylate and styrene is grafted onto a graft base based on 1,3-butadiene or onto a graft base composed of a mixture of 1,3-butadiene and styrene, which are also referred to as MBS (methyl methacrylate-butadiene-styrene) rubbers. Particular preference is likewise given according to the invention to graft copolymers in which acrylonitrile or a mixture of acrylonitrile and styrene is grafted onto a graft base based on 1,3-butadiene or onto a graft base composed of a mixture of 1,3-butadiene and styrene, which are also referred to as ABS (acrylonitrile-butadiene-styrene) rubbers.

There are preferably used as component D) also graft copolymers in which n-butyl acrylate, n-butyl methacrylate, ethyl acrylate, methyl acrylate, 1,3-butadiene, isoprene and/or 2-ethylhexyl acrylate are grafted onto a graft base of 1,3-butadiene, isoprene, n-butyl acrylate, styrene and/or 2-ethylhexyl acrylate.

The monomer mixtures grafted onto the graft base may expressly also comprise additional reactive groups, such as, for example, epoxy or glycidyl, carboxyl, carboxylic anhydride, amino and/or amide groups, functionalised monomers having an ethylenic double bond, such as, for example, acylamide, methacrylamide, (N,N-dimethylamino)ethyl acrylate, preferably maleic acid, fumaric acid, maleic anhydride, allyl glycidyl ether, vinyl glycidyl ether, glycidyl acrylate, glycidyl methacrylate.

According to the invention, crosslinking monomers, such as, for example, divinylbenzene, diallyl phthalate, dihydrodicyclopentadiene acrylate and/or 1,3-butadiene, may also be polymerised into the graft base and/or into outer shells.

It is also possible to use so-called graft-crosslinking monomers, which possess at least two polymerisable double bonds, the double bonds polymerising at different rates during the polymerisation. Preferably, one double bond polymerises at approximately the same rate as the other monomers, while the other double bond(s) polymerise(s) markedly more slowly, so that a specific content of double bonds is thus obtained in the rubber. When a further phase is grafted on, parts of these double bonds are able to react with the graft monomers and thus partially chemically bind the grafted phase to the graft base. Examples which may be mentioned here include ethylenically unsaturated carboxylic acid esters, such as allyl acrylate, allyl methacrylate, diallyl maleate, diallyl fumarate, or compounds mentioned in U.S. Pat. No. 4,148,846.

Component D preferably comprises one or more graft polymers of
D.1 from 5 to 95 wt. %, preferably from 30 to 90 wt. %, of at least one vinyl monomer on
D.2 from 95 to 5 wt. %, preferably from 70 to 10 wt. %, of one or more graft bases having glass transition temperatures <10° C., preferably <0° C., particularly preferably <−20° C.

The graft base D.2 generally has a mean particle size (d₅₀ value) of from 0.05 to 10 μm, preferably from 0.1 to 5 μm, particularly preferably from 0.2 to 1 μm.

Monomers D.1 are preferably mixtures of
D.1.1 from 50 to 99 wt. % vinyl aromatic compounds and/or vinyl aromatic compounds substituted on the ring (such as, for example, styrene, α-methylstyrene, p-methylstyrene, p-chlorostyrene) and/or methacrylic acid (C₁-C₈)-alkyl esters (such as, for example, methyl methacrylate, ethyl methacrylate) and
D.1.2 from 1 to 50 wt. % vinyl cyanides (unsaturated nitriles, such as acrylonitrile and methacrylonitrile) and/or (meth)acrylic acid (C₁-C₈)-alkyl esters (such as, for example, methyl methacrylate, n-butyl acrylate, tert.-butyl acrylate) and/or derivatives (such as anhydrides and imides) of unsaturated carboxylic acids (for example maleic anhydride and N-phenylmaleimide).

Preferred monomers D.1.1 are selected from at least one of the monomers styrene, α-methylstyrene and methyl methacrylate; preferred monomers D.1.2 are selected from at least one of the monomers acrylonitrile, maleic anhydride and methyl methacrylate.

Particularly preferred monomers are D.1.1 styrene and D.1.2 acrylonitrile.

Suitable graft bases D.2 for the graft polymers D are, for example, diene rubbers, EP(D)M rubbers, that is to say those based on ethylene/propylene and optionally diene, acrylate, polyurethane, silicone, chloroprene and ethylene/vinyl acetate rubbers.

Preferred graft bases D.2 are diene rubbers (e.g. based on butadiene, isoprene, etc.) or mixtures of diene rubbers or copolymers of diene rubbers or mixtures thereof with further copolymerisable monomers (e.g. according to D.1.1 and D.1.2), with the proviso that the glass transition temperature of component D.2 is <10° C., preferably <0° C., particularly preferably <−10° C.

Pure polybutadiene rubber is particularly preferred.

Particularly preferred polymers D are, for example, ABS polymers (emulsion, mass and suspension ABS), as are described, for example, in DE-A 2 035 390 (=U.S. Pat. No. 3,644,574) or in DE-A 2 248 242 (=GB-A 1 409 275) or in Ullmann, Enzyklopädie der Technischen Chemie, Vol. 19 (1980), p. 280 ff. The gel content of the graft base D.2 is at least 30 wt. %, preferably at least 40 wt. % (measured in toluene).

The graft copolymers D are prepared by free-radical polymerisation, for example by emulsion, suspension, solution or mass polymerisation, preferably by emulsion or mass polymerisation.

Particularly suitable graft rubbers are also ABS polymers prepared by redox initiation with an initiator system of organic hydroperoxide and ascorbic acid according to U.S. Pat. No. 4,937,285.

Because it is known that the graft monomers are not necessarily grafted completely onto the graft base during the graft reaction, graft polymers D are also understood according to the invention as being those products that are obtained by (co)polymerisation of the graft monomers in the presence of the graft base and that are obtained concomitantly during working up.

Suitable acrylate rubbers according to D.2 for the polymers D are preferably polymers of acrylic acid alkyl esters, optionally containing up to 40 wt. %, based on D.2, of other polymerisable, ethylenically unsaturated monomers. The preferred polymerisable acrylic acid esters include C₁-C₈-alkyl esters, for example methyl, ethyl, butyl, n-octyl and 2-ethylhexyl esters; haloalkyl esters, preferably halo-C₁-C₈-alkyl esters, such as chloroethyl acrylate, and mixtures of these monomers.

For crosslinking, monomers having more than one polymerisable double bond can be copolymerised. Preferred examples of crosslinking monomers are esters of unsaturated monocarboxylic acids having from 3 to 8 carbon atoms and unsaturated monohydric alcohols having from 3 to 12 carbon atoms, or saturated polyols having from 2 to 4 OH groups and from 2 to 20 carbon atoms, such as, for example, ethylene glycol dimethacrylate, allyl methacrylate; polyunsaturated heterocyclic compounds, such as, for example, trivinyl cyanurate and triallyl cyanurate; polyfunctional vinyl compounds, such as di- and tri-vinylbenzenes; and also triallyl phosphate and diallyl phthalate.

Preferred crosslinking monomers are allyl methacrylate, ethylene glycol dimethacrylate, diallyl phthalate, and heterocyclic compounds containing at least 3 ethylenically unsaturated groups.

Particularly preferred crosslinking monomers are the cyclic monomers triallyl cyanurate, triallyl isocyanurate, triacryloylhexahydro-s-triazine, triallyl benzenes. The amount of crosslinking monomers is preferably from 0.02 to 5 wt. %, especially from 0.05 to 2 wt. %, based on the graft base D.2.

In the case of cyclic crosslinking monomers having at least 3 ethylenically unsaturated groups, it is advantageous to limit the amount to less than 1 wt. % of the graft base D.2.

Preferred “other” polymerisable, ethylenically unsaturated monomers which can optionally be used, in addition to the acrylic acid esters, in the preparation of the graft base D.2 are, for example, acrylonitrile, styrene, α-methylstyrene, acrylamides, vinyl C₁-C₆-alkyl ethers, methyl methacrylate, butadiene. Preferred acrylate rubbers as the graft base D.2 are emulsion polymers having a gel content of at least 60 wt. %.

Further suitable graft bases according to D.2 are silicone rubbers having graft-active sites, as are described in DE-A 3 704 657, DE-A 3 704 655, DE-A 3 631 540 and DE-A 3 631 539.

The gel content of the graft base D.2 is determined at 25° C. in a suitable solvent (M. Hoffmann, H. Krömer, R. Kuhn, Polymeranalytik I und II, Georg Thieme-Verlag, Stuttgart 1977).

Component D) preferably also comprises one graft polymer, or a mixture of two or more different graft polymers, having a graft base based on acrylates having a glass transition temperature below −5° C. (such graft polymers are generally referred to as acrylate rubbers and are known to the person skilled in the art) or one resilient block polymer, or a mixture of two or more different resilient block polymers, especially two- or three-block copolymers, based on vinyl aromatic compounds and dienes, or mixtures of graft polymers and resilient block polymers, which are described in greater detail as D′ and are included in the general designation component D.

The acrylate rubbers D′) described above as also being preferably usable preferably include graft copolymers having elastomeric properties, which are obtainable substantially from at least 2 of the following monomers: (meth)acrylic acid esters having from 1 to 18 carbon atoms in the alcohol component, chloroprene, 1,3-butadiene, isopropene, styrene, acrylonitrile, ethylene, propylene and vinyl acetate, the graft base containing at least one (meth)acrylic acid ester, that is to say polymers such as are likewise described, for example, in “Methoden der Organischen Chemie” (Houben-Weyl), Vol. 14/1, Georg Thieme-Verlag, Stuttgart 1961, p. 393-406 and in C. B. Bucknall, “Toughened Plastics”, Appl. Science Publishers, London 1977.

Preferred polymers D′) are partially crosslinked and have gel contents of over 5 wt. %, preferably 20 wt. %, more preferably over 40 wt. %, especially over 60 wt. %.

Preferred acrylate rubbers D′) as component D) are graft copolymers containing
D′.1) from 95 to 5 wt. %, preferably from 10 to 80 wt. %, based on component D, of graft base based on at least one polymerisable, ethylenically unsaturated monomer as graft monomer and
D′.2) from 5 to 95 wt. %, preferably from 20 to 90 wt. %, based on component D, of acrylate rubber having a glass transition temperature <−10° C., preferably <−20° C., as graft base. Particularly preferably, D′.2) may comprise polymers of acrylic acid esters or methacrylic acid esters which may contain up to 40 wt. %, based on D′.2), of other ethylenically unsaturated monomers.

The acrylate rubbers according to D′.2 are preferably polymers of acrylic acid alkyl esters or methacrylic acid alkyl esters, optionally with tip to 40 wt. %, based on D′.2, of other polymerisable, ethylenically unsaturated monomers. Preferred acrylic acid esters or methacrylic acid esters include C₁-C₈-alkyl esters, especially methyl, ethyl, butyl, n-octyl and 2-ethylhexyl esters; and also haloalkyl esters, preferably halo-C₁-C₈-alkyl esters, such as chloro-ethyl acrylate, and mixtures of these monomers.

Acrylic acid alkyl esters and methacrylic acid esters are preferably esters of acrylic acid or methacrylic acid with monohydric alcohols having from 1 to 18 carbon atoms. Particular preference is given to methacrylic acid methyl esters, ethyl esters and propyl esters, n-butyl acrylate, tert.-butyl acrylate and tert.-butyl methacrylate.

Graft monomers of the graft base D′. 1 are preferably selected from at least one monomer, preferably 2 or 3 monomers, from the group consisting of styrene, α-methylstyrene, styrenes substituted on the ring by halogen or by methyl, (meth)acrylic acid C₁-C₈-alkyl esters, acrylonitrile, methacrylonitrile, maleic anhydride, C₁-C₄-alkyl- or phenyl-N-substituted maleimides, or mixtures thereof.

Particularly preferred graft copolymers D′) comprise graft polymers of:
D′.1) from 5 to 95 parts by weight, preferably from 10 to 80 parts by weight, especially from 30 to 80 parts by weight, of a mixture of
D′.1.1 from 50 to 99 wt. %, preferably from 65 to 90 wt. %, methyl methacrylate, styrene, α-methylstyrene, styrenes substituted on the ring by halogen or by methyl, or mixtures of these compounds and
D′.1.2 from 1 to 50 wt. %, preferably from 35 to 10 wt. %, methyl methacrylate, acrylonitrile, methacrylonitrile, maleic anhydride, C₁-C₄-alkyl- or phenyl-N-substituted maleimides, or mixtures of these compounds, on
D′.2) from 5 to 95 parts by weight, preferably from 20 to 90 parts by weight, especially from 20 to 70 parts by weight, of polymer based on alkyl acrylate and having a glass transition temperature below −10° C., preferably less than −20° C.,
   the sum of the parts by weight of D′.1) and D′.2) being 100.

Particular preference is given to graft copolymers D′) which are obtainable by graft reaction of
α from 10 to 70 wt. %, preferably from 15 to 50 wt. %, especially from 20 to 40 wt. %, based on graft polymer D′, of at least one (meth)acrylic acid ester, or from 10 to 70 wt. %, preferably from 15 to 50 wt. %, especially from 20 to 40 wt. %, of a mixture of from 10 to 50 wt. %, preferably from 20 to 35 wt. %, based on the mixture, of acrylonitrile or (meth)acrylic acid ester and from 50 to 90 wt. %, preferably from 65 to 80 wt. %, based on the mixture, of styrene, as graft base D′.1, on
β from 30 to 90 wt. %, preferably from 50 to 85 wt. %, especially from 60 to 80 wt. %, based on graft polymer D′), of a graft base D′.2) which contains from 70 to 100 wt. % of at least one alkyl acrylate having from 1 to 8 carbon atoms in the alkyl radical, preferably n-butyl acrylate and/or methyl n-butyl acrylate and/or 2-ethylhexyl acrylate, especially n-butyl acrylate, as the only alkyl acrylate, from 0 to 30 wt. %, preferably from 0 to 15 wt. %, of a further copolymerisable monoethylenically unsaturated monomer, such as butadiene, isoprene, styrene, acrylonitrile, methyl methacrylate or vinyl methyl ether or mixtures thereof, from 0 to 5 wt. % of a copolymerisable, polyfunctional, preferably bi- and tri-functional, monomer that effects crosslinking, the amounts by weight being based on the total weight of the graft base.

Preferred graft polymers D′) based on acrylate rubbers are, for example, bases D′.2) grafted with (meth)acrylic acid alkyl esters and/or styrene and/or acrylonitrile. Acrylate rubbers based on n-butyl acrylate are particularly preferred as the graft base D′.2).

Particularly preferred graft polymers D′) based on acrylate rubbers are especially those which contain less than 5 wt. % polystyrene units, preferably less than 1 wt. % polystyrene units, based on the total weight of the graft, particularly preferably those which do not contain any polystyrene units.

Component D) may also be a mixture of different graft copolymers.

The gel content of the graft base β of the graft copolymer D′) is generally at least 20 wt. %, preferably 40 wt. % (measured in toluene), and the degree of grafting G is generally from 0.15 to 0.55.

The mean particle diameter of the graft copolymer D′) is preferably from 0.01 to 2 μm, more preferably from 0.05 to 1.0 μm, particularly preferably from 0.1 to 0.08 μm, especially from 0.1 to 0.4 μm.

The mean particle diameter is determined, for example, on electron microscope pictures (TEM) of ultra-thin sections of the moulding compositions according to the invention, treated with OSO₄ and RuO₄, by measuring a representative quantity (about 50) of particles.

The mean particle size d₅₀, determined by means of ultracentrifugation (W. Scholtan, H. Lange, Kolloid, Z. und Z. Polymere 250 (1972), 782-796), is the diameter above and below which in each case 50 wt. % of the particles lie. The mean particle size d₅₀ of the graft polymers D) (or D′) is preferably from 0.08 to 0.6 μm, particularly preferably from 0.1 to 0.4 μm.

The gel content of the graft bases D.2 (or D′.2) is determined at 25° C. in dimethylformamide (M. Hoffmann, H. Krömer, R. Kuhn, Polymeranalytik I und II, Georg Thieme-Verlag, Stuttgart 1977).

The degree of grafting G denotes the weight ratio of grafted graft monomers to the graft base and is dimensionless.

For crosslinking preferably of the polymers D) based on acrylate rubbers, monomers having more than one polymerisable double bond can be copolymerised. Preferred examples of crosslinking monomers are esters of unsaturated monocarboxylic acids having from 3 to 8 carbon atoms and unsaturated monohydric alcohols having from 3 to 12 carbon atoms, or saturated polyols having from 2 to 4 OH groups and from 2 to 20 carbon atoms, such as, for example, ethylene glycol dimethacrylate, allyl methacrylate; polyunsaturated heterocyclic compounds, such as, for example, trivinyl cyanurate and triallyl cyanurate; polyfunctional vinyl compounds, such as di-and tri-vinylbenzenes; and also triallyl phosphate and diallyl phthalate. Preferred crosslinking monomers are allyl methacrylate, ethylene glycol dimethacrylate, diallyl phthalate, and heterocyclic compounds containing at least 3 ethylenically unsaturated groups. Particularly preferred crosslinking monomers are the cyclic monomers triallyl cyanurate, triallyl isocyanurate, trivinyl cyanurate, triacryloylhexahydro-s-triazine, triallyl benzenes, acrylic acid esters of tricyclodecenyl alcohol.

The amount of crosslinking monomers is preferably from 0.02 to 5 wt. %, especially from 0.05 to 2 wt. %, based on the graft base D.2.

In the case of cyclic crosslinking monomers having at least 3 ethylenically unsaturated groups, it is advantageous to limit the amount to less than 1 wt. % of the graft base D.2.

The graft polymers D) can be prepared by known processes, such as mass, suspension, emulsion or mass-suspension processes.

Because it is known that the graft monomers are not necessarily grafted completely onto the graft base during the graft reaction, graft polymers D) are also understood according to the invention as being those products that are obtained by polymerisation of the graft monomers in the presence of the graft base.

The graft polymers D) are preferably used in compacted form.

Component D) according to the invention further comprises block polymers having elastomeric properties, especially, for example, two-(A-B) and three-(A-B-A) block copolymers. Block copolymers of type A-B and A-B-A can exhibit typical behaviour of thermoplastic elastomers. The preferred block copolymers of type A-B and A-B-A contain one or two vinyl aromatic blocks (particularly preferably based on styrene) and a rubber block (particularly preferably a diene rubber block, most preferably a polybutadiene block or isoprene block), which in particular may also optionally be partially or completely hydrogenated.

Suitable block copolymers of type A-B and A-B-A are described, for example, in U.S. Pat. Nos. 3,078,254, 3,402,159, 3,297,793, 3,265,765 and 3,594,452 and in GB-A 1 264 741. Examples of typical block copolymers of type A-B and A-B-A are: polystyrene-polybutadiene (SBR), polystyrene-poly(ethylene-propylene), polystyrene-polyisoprene, poly(ε-methylstyrene)-polybutadiene, polystyrene-polybutadiene-polystyrene (SBR), polystyrene-poly(ethylene-propylene)-polystyrene, polystyrene-polyisoprene-polystyrene and poly(ε-methylstyrene)-polybutadiene-poly(ε-methylstyrene), as well as hydrogenated versions thereof, such as, for example and preferably, hydrogenated polystyrene-polybutadiene-polystyrene (SEBS) and hydrogenated polystyrene-polyisoprene (SEP). The use of corresponding hydrogenated block copolymers optionally in admixture with the unhydrogenated precursor as impact modifier is described, for example, in DE-A 2 750 515, DE-A 2 434 848, DE-A 038 551, EP-A 0 080 666 and WO-A 83/01254. The mentioned publications are incorporated herein by reference.

Mixtures of the mentioned block polymers can likewise be used.

Particular preference is given to partially or completely hydrogenated block copolymers, very particular preference being given to hydrogenated polystyrene-polybutadiene-polystyrene (SEBS) and hydrogenated polystyrene-polyisoprene (SEP).

Such block polymers of type A-B and A-B-A are commercially available from a number of sources, for example from Phillips Petroleum under the commercial name SOLPRENE, from Shell Chemical Co. under the commercial name KRATON, from Dexco under the commercial name VECTOR and from Kuraray under the commercial name SEPTON.

Component D) further comprises also one or more rubber-modified graft polymers. The rubber-modified graft polymer D′ comprises a random (co)polymer of vinyl monomers D′.1, preferably according to D′.1.1 and D′.1.2, as well as a rubber D′.2 grafted with vinyl monomers, preferably according to D′. 1.1 and D′. 1.2. The preparation of D is carried out in known manner by free-radical polymerisation, for example according to an emulsion, mass or solution or mass-suspension polymerisation process, as described, for example, in U.S. Pat. No. 3,243,481.

Preference is given to one or more graft polymers of from 5 to 95 wt. %, preferably from 20 to 90 wt. %, of at least one vinyl monomer D′.1 on from 95 to 5 wt. %, preferably from 80 to 10 wt. %, of one or more graft bases D′.2 having glass transition temperatures <10° C., preferably <−10° C.

Preferred monomers D′. 1.1 are styrene, α-methylstyrene, styrenes substituted on the ring by halogen or by alkyl, such as p-methylstyrene, p-chlorostyrene, (meth)acrylic acid C₁-C₈-alkyl esters, such as methyl methacrylate, n-butyl acrylate and tert.-butyl acrylate. Preferred monomers D′.1.2 are unsaturated nitrites, such as acrylonitrile, methacrylonitrile, (meth)acrylic acid C₁-C₈-alkyl esters, such as methyl methacrylate, n-butyl acrylate, tert.-butyl acrylate, derivatives (such as anhydrides and imides) of unsaturated carboxylic acids, such as maleic anhydride and N-phenylmaleimide, or mixtures thereof.

Particularly preferred monomers D′.1.1 are styrene, α-methylstyrene and/or methyl methacrylate; particularly preferred monomers D′.1.2 are acrylonitrile, maleic anhydride and/or methyl methacrylate.

Particularly preferred monomers are D′1.1 styrene and D′1.2 acrylonitrile.

Suitable rubbers D′.2 for the rubber-modified graft polymers D′ are, for example, diene rubbers, acrylate, polyurethane, silicone, chloroprene and ethylene/vinyl acetate rubbers. Composites of various of the mentioned rubbers are likewise suitable as graft bases.

Preferred rubbers D′.2 are diene rubbers (e.g. based on butadiene, isoprene, etc.) or mixtures of diene rubbers or copolymers of diene rubbers or mixtures thereof with further copolymerisable vinyl monomers (e.g. according to D′.1.1 and D′.1.2), with the proviso that the glass transition temperature of component D′.2 is below 10° C., preferably below −10° C. Pure polybutadiene rubber is particularly preferred. Further copolymerisable monomers may be present in the rubber base in an amount of up to 50 wt. %, preferably up to 30 wt. %, especially up to 20 wt. % (based on the rubber base D′.2).

Suitable acrylate rubbers according to D′.2 for the polymers D′ are preferably polymers of acrylic acid alkyl esters, optionally containing up to 40 wt. %, based on D′.2, of other polymerisable, ethylenically unsaturated monomers. The preferred polymerisable acrylic acid esters include C₁-to C₈-alkyl esters, for example methyl, ethyl, butyl, n-octyl and 2-ethylhexyl esters; haloalkyl esters, preferably halo-C₁-C₈-alkyl esters, such as chloroethyl acrylate, and mixtures of these monomers.

Preferred “other” polymerisable, ethylenically unsaturated monomers which can optionally be used, in addition to the acrylic acid esters, in the preparation of the graft base D′.2 are, for example, acrylonitrile, styrene, α-methylstyrene, acrylamides, vinyl C₁-C₆-alkyl ethers, methyl methacrylate, butadiene. Preferred acrylate rubbers as the graft base D′.2 are emulsion polymers having a gel content of at least 60 wt. %.

Further suitable graft bases according to D′.2 are silicone rubbers having graft-active sites, as are described, for example, in DE-A 3 704 657 .

As component E).the compositions according to the invention may further comprise conventional additives, which can be added generally to 15, preferably in an amount of from 0.01 to 10 wt. %, particularly preferably from 0.05 to 5 wt. %, especially preferably from 0.1 to 3 wt. %, based on the total weight of the moulding compositions.

All conventional additives are suitable, such as, for example, stabilisers (for example UV stabilisers, heat stabilisers), antistatics, flow aids, mould-release agents, fireproofing additives, emulsifiers, nucleating agents, plasticisers, lubricants, additives that lower the pH value (e.g. compounds containing carboxyl groups), additives for increasing conductivity, colourings and pigments. The mentioned additives and further suitable additives are described, for example, in Gächter, Müller, Kunststoff-Additive, 3rd Edition, Hanser-Verlag, Munich, Vienna, 1989. The additives may be used on their own or in a mixture or in the form of masterbatches. The additives can be mixed in and/or applied to the surface.

As stabilisers there may be used, for example, sterically hindered phenols and/or phosphites, hydroquinones, aromatic secondary amines, such as diphenylamines, substituted resorcinols, salicylates, benzotriazoles and benzophenones, as well as variously substituted representatives of these groups, and mixtures thereof.

As nucleating agents there may be used, for example, sodium phenylphosphinate, aluminium oxide, silicon dioxide and, preferably, talcum and the nucleating agents described hereinbefore.

As lubricants and mould-release agents there may be used ester waxes, pentaerythritol tristearate (PETS), long-chained fatty acids (e.g. stearic acid or behenic acid), salts thereof (e.g. Ca or Zn stearate) as well as amide derivatives (e.g. ethylene-bis-stearylamide) or montan waxes (mixtures of straight-chain, saturated carboxylic acids having chain lengths of from 28 to 32 carbon atoms) and also low molecular weight polyethylene or polypropylene waxes.

As plasticisers there may be used, for example, phthalic acid dioctyl esters, phthalic acid dibenzyl esters, phthalic acid butylbenzyl esters, hydrocarbon oils, N-(n-butyl)benzenesulfonamide.

In order to obtain conductive moulding compositions it is possible to add carbon blacks, conductivity carbon blacks, carbon fibrils, nano-scale graphite fibres (nanotubes), graphite, conductive polymers, metal fibres as well as other conventional additives for increasing conductivity.

As flameproofing agents there may be used commercially available organic halogen compounds with synergists, or commercially available organic nitrogen compounds or organic/inorganic phosphorus compounds, individually or in a mixture. Mineral flameproofing additives, such as magnesium hydroxide or Ca-Mg carbonate hydrates (e.g. DE-A 4 236 122) can also be used. Examples of halogen-containing, especially brominated and chlorinated, compounds which may be mentioned include: ethylene-1,2-bistetrabromophthalimide, epoxidised tetrabromobisphenol A resin, tetrabromobisphenol A oligocarbonate, tetrachlorobisphenol A oligocarbonate, pentabromopolyacrylate, brominated polystyrene. Suitable organic phosphorus compounds are the phosphorus compounds according to WO-A 98/17720 (PCT/EP/05705), for example triphenyl phosphate (TPP), resorcinol bis-(diphenyl-phosphate), including oligomers, as well as bisphenol A bis-diphenylphosphate, including oligomers (see e.g. EP-A 363 608 and EP-A 640 655), melamine phosphate, melamine pyrophosphate, melamine polyphosphate and mixtures thereof. Suitable nitrogen compounds are especially melamine and melamine cyanurate. There are suitable as synergists, for example, antimony compounds, especially antimony trioxide and antimony pentoxide, zinc compounds, tin compounds, such as, for example, tin stannate, and borates. Carbon formers and tetrafluoroethylene polymers can be added. The flameproofing agents, optionally with a synergist, such as antimony compounds, and antidripping agents are generally used up to an amount of 30 wt. %, preferably 20 wt. % (based on the composition as a whole).

Reinforcing materials, for example in the form of glass fibres, may also be added as additives.

As component F) the thermoplastic moulding compositions may further comprise a filler or reinforcing material or a mixture of two or more different fillers and/or reinforcing materials, for example based on talc, mica, silicate, quartz, titanium dioxide, wollastonite, kaolin, amorphous silicas, magnesium carbonate, chalk, feldspar, barium sulfate, glass spheres and/or fibrous fillers and/or reinforcing materials based on carbon fibres and/or glass fibres. Preference is given to the use of particulate mineral fillers based on talc, mica, silicate, quartz, titanium dioxide, wollastonite, kaolin, amorphous silicas, magnesium carbonate, chalk, feldspar, barium sulfate and/or glass fibres. Particular preference is given according to the invention to particulate mineral fillers based on talc, wollastonite and/or glass fibres. Fillers based on talc are most preferred.

In particular for applications in which isotropy in dimensional stability and high thermal dimensional stability are required, such as, for example, in motor vehicle applications for external bodywork parts, mineral fillers are preferably used, particularly preferably talc, wollastonite or kaolin.

Particular preference is given also to needle-like mineral fillers. According to the invention, a needle-like mineral filler is understood as being a mineral filler having a highly pronounced needle-like nature. Relatively needle-like wollastonites may be mentioned as an example. The mineral has a length:diameter ratio of preferably from 2:1 to 35:1, particularly preferably from 3:1 to 19:1, most preferably from 4:1 to 12:1. The mean particle size of the needle-like minerals according to the invention is preferably less than 20 μm, particularly preferably less than 15 μm, especially preferably less than 10 μm, most preferably less than 5 μm, determined using a CILAS GRANULOMETER.

Most preferred as component F) are mineral fillers based on talc. Suitable talc-based mineral fillers within the scope of the invention are all particulate fillers which the person skilled in the art associates with talc or talcum. Likewise suitable are all particulate fillers which are supplied commercially and whose product descriptions contain the term talc or talcum as characterising features.

Preference is given to mineral fillers having a talc content, according to DIN 55920, of greater than 50 wt. %, preferably greater than 80 wt. %, particularly preferably greater than 95 wt. % and especially preferably greater than 98 wt. %, based on the total weight of filler.

The talc-based mineral fillers may also be surface-treated. They may, for example, be provided with an adhesion promoter system, for example based on silane.

Preferably, the talc-based mineral fillers according to the invention have an upper particle or grain size d97 of less than 50 μm, preferably less than 10 μm, particularly preferably less than 6 μm and especially preferably less than 2.5 μm. As the mean grain size d50 there is preferably chosen a value of less than 10, preferably less than 6, particularly preferably less than 2 and especially preferably less than 1 μm. The d97 and d50 values of the fillers F are determined by sedimentation analysis SEDIGRAPH D 5 000 or by screen analysis DIN 66 165.

The mean aspect ratio (diameter to thickness) of the particulate talc-based fillers is preferably in the range from 1 to 100, particularly preferably from 2 to 25 and especially preferably from 5 to 25, determined on electron microscope pictures of ultra-thin sections of the finished products and measurement of a representative quantity (about 50) of filler particles.

The filler and/or reinforcing material may optionally be surface-modified, for example with an adhesion promoter or adhesion promoter system, e.g. based on silane. Pretreatment is not absolutely necessary, however. In particular when glass fibres are used, it is possible to employ, in addition to silanes, also polymer dispersions, film formers, branching agents and/or glass fibre processing aids.

Particular preference is given according to the invention also to glass fibres that generally have a fibre diameter of from 7 to 18 μm, preferably from 9 to 15 μm, and that can be added in the form of continuous fibres or in the form of chopped or ground glass fibres, it being possible for the fibres to be provided with a suitable size system and an adhesion promoter or adhesion promoter system, e.g. based on silane.

Conventional silane compounds for pretreatment have, for example, the general formula
(X—(CH2)q)k-Si—(O—CrH2r+1)4-k
in which the substituents have the following meanings:
x NH2-, HO—, 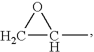
q is an integer from 2 to 10, preferably 3 or 4,
r is an integer from 1 to 5, preferably 1 or 2,
k is an integer from 1 to 3, preferably 1.

Preferred silane compounds are aminopropyltrimethoxysilane, aminobutyl-trimethoxysilane, aminopropyltriethoxysilane, aminobutyltriethoxysilane and the corresponding silanes that contain a glycidyl group as the substituent X.

The silane compounds are generally used for surface coating in amounts of from 0.05 to wt. %, preferably from 0.5 to 1.5 wt. % and especially from 0.8 to 1 wt. %, based on the mineral filler.

As result of processing to the moulding composition or moulded body, the particulate fillers in the moulding composition or in the moulded body may have a smaller d97 or d50 value than the fillers originally used. As a result of processing to the moulding composition or moulded body, the glass fibres in the moulding composition or moulded body may have shorter length distributions than originally used.

The particle diameters in the finished product can be determined, for example, by taking electron microscope pictures of thin sections of the polymer mixture and using at least 25, preferably at least 50, filler particles for the evaluation.

The compositions used according to the invention are prepared by processes known per se, by mixing the components. It may be advantageous to premix individual components. The mixing of components A to D and of further constituents is preferably carried out at temperatures of from 220 to .330° C. by kneading, extruding or rolling the components together.

The compositions used according to the invention can be processed to semi-finished products or mouldings of any kind by conventional methods. Examples of processing methods which may be mentioned include extrusion processes and injection-moulding processes. Examples of semi-finished products which may be mentioned include films and sheets.

According to the invention, the mouldings are lacquered with at least one aqueous lacquer after they have been produced; in the case of the use of multi-layer lacquer systems in which the individual lacquer layers can be produced using solvent-containing or aqueous lacquers, at least the lacquer layer that is applied directly to the substrate is aqueous according to the invention.

Aqueous lacquer systems may contain up to 30% organic co-solvent. Today's state of the art systems contain from 10 to 5% organic co-solvent. Ideally, aqueous lacquer systems do not contain any co-solvent.

Co-solvents are the lacquer solvents used in the lacquers industry. They are required, inter alia, for dispersion and also as coalescence aids.

Aqueous lacquer systems may be 1K systems, for example physically drying systems or systems having blocked curing agents that are unblocked at elevated temperatures and then crosslink by a chemical reaction, or 2K systems. 2K systems cure by means of a chemical reaction, where one reaction partner would already cure under storage conditions. The components are therefore only mixed with one another shortly before application. 2K systems have the disadvantage that the installation is more complex and their processability after mixing is limited in terms of time. The advantage of 2K systems is the better quality of the resulting coating.

Particular mention may be made here of aqueous 2K PUR lacquers, in which the crosslinking mechanism is the reaction of isocyanate groups with OH groups.

In order to obtain an optimum lacquering result, the substrate must be clean. This is frequently ensured on an industrial scale by the use of a “power wash” installation. However, it is also entirely possible to clean the surface using solvents.

If the surface polarity after cleaning is inadequate, the surface can be activated inter alia by
flame treatment
fluorination
plasma treatment or corona treatment.

Furthermore, it is possible to produce adhesion of the lacquer by the use of an adhesive primer.

An electrically conductive surface can be generated by the use of so-called conductive primers.

It is preferable to lacquer the mouldings directly with an aqueous lacquer after cleaning, without pretreatment. In a very particularly preferred form, the aqueous lacquer is a colour-giving hydro-based lacquer. The hydro-based lacquer may preferably be covered with a layer of a solvent-containing, aqueous or solvent-free clear lacquer.

The moulding compositions used according to the invention are particularly preferably processed to form mouldings for the internal and external sector, preferably in the motor vehicle external sector, such as, for example, bumpers, wings, doors or door parts, tank covers, bonnets, sun visors and rear visors, air-inlet grills, spoilers, load areas, covers for load areas, roofs or roof parts, and are lacquered with at least one hydro lacquer. The mouldings may be small or large.

Mouldings or semi-finished products produced from the moulding compositions/preparations used according to the invention may also be used in conjunction with other materials, such as, for example, metal or plastics. The moulding compositions according to the invention, or the mouldings/semi-finished products produced from the moulding compositions used according to the invention, can, by means of conventional techniques for connecting and joining a plurality of components or parts, such as, for example, coextrusion, injection-moulding on the back of films, injection-moulding around inserts, adhesive bonding, welding, screwing or clamping, be used in conjunction with other materials, or can themselves be used, for the manufacture of finished articles, such as, for example, external bodywork parts.

The mouldings according to the invention can also be used for numerous other applications lacquered with hydro lacquers. Examples which may be mentioned include use in electronics and electrical engineering and also in the construction sector. In the mentioned fields of use, mouldings produced from the moulding compositions according to the invention can be used, for example, as lamp covers, as safety glazing, as casing material for electronic devices, as casing material for domestic appliances, as sheets for the production of covers.

The lacquered mouldings according to the invention based on the moulding compositions according to the invention are distinguished by excellent lacquer adhesion. The lacquer adhesion can be tested, for example, by the cross-cut test, the tape test and/or, preferably, the steam jet test according to DaimlerChrysler standard DBL 5431. The lacquer adhesion in the case of the moulding compositions according to the invention is very critical particularly in those areas in which shear friction occurs during removal of the moulding from the mould. Moreover, the moulding compositions according to the invention meet high demands in respect of processing stability, flowability of the melt, strength, low-temperature strength, rigidity, dimensional stability under heat, thermal expansion, surface quality, lacquerability, resistance to chemicals and resistance to fuel.

### Examples

Component A

Linear polybutylene terephthalate (Pocan B 1500, commercial product of Bayer AG, Leverkusen, Germany) having an intrinsic viscosity of about 1.25 cm³/g (measured in phenol: 1,2-dichlorobenzene=1:1 at 25° C.).

Component B

Polyethylene terephthalate: This is polyethylene terephthalate having an intrinsic viscosity IV of 0.74 cm³/g and an isothermal crystallisation time at 215° C. of about 4.2 minutes.

The intrinsic viscosity is measured in phenol/o-dichlorobenzene (1:1 parts by weight) at 25° C.

The determination of the isothermal crystallisation time of PET by the DSC method (differential scanning calorimetry) is carried out using a PERKIN ELMER DSC 7 differential scanning calorimeter (weighed amount about 10 mg, perforated A1 pan) with the following temperature programme:
1. heating from 30° C. to 290° C. at 40° C./min,
2. 5 min isothermal at 290° C.,
3. cooling from 290° C. to 215° C. at 160° C./min,
4. 30 min isothermal at 215° C. (crystallisation temperature).

The evaluation software is PE Thermal Analysis 4.00.

Component C

Linear polycarbonate (Makrolon 2805 from Bayer AG, Leverkusen, Germany) based on bisphenol A and having a viscosity ηrel. of about 1.29 (measuring conditions: 5 g of polycarbonate per litre of methylene chloride, 25° C.) and a molecular weight Mw of about 29,000 g/mol. (determined by GPC methods against polycarbonate standard).

Component D

ABS graft copolymer (type P7528B4, test product of Bayer AG, Leverkusen) having a particle size of from 280 to 400 nm.

Component E

As additives of component E there was used a mixture of conventional stabilisers, nucleating agents and mould-release agents.

Compounding was carried out on a ZSK32 twin-shaft extruder (Werner und Pfleiderer) at composition temperatures of from 250 to 290° C.

The test specimens were injection-moulded on an Arburg 320-210-500 injection-moulding machine at composition temperatures of from 260 to 280° C. and tool temperatures of from 70 to 90° C.

The moulding compositions according to the invention were tested according to the following methods:

Vicat B: dimensional stability under heat according to DIN ISO 306/B 120 in silicone oil.

Izod impact strength: strength according to ISO 180 method 1 U at −50° C.

Izod notched impact strength: strength according to ISO 180 method 1 A at −20° C.

Tensile modulus: rigidity according to DIN/EN/ISO 527-2/1 A.

Ultimate elongation: extensibility determined according to DIN/EN/ISO 527-2/1A.

Melt viscosity: determined according to DIN 54811/ISO 11443 at 280° C. and a shear rate of 1000 s⁻¹ using a Viscorobo 94.00 device from Gottfert after drying of the granules at 120° C. for 4 hours in a vacuum dryer.

Testing of the lacquer adhesion was carried out by the steam jet test according to DaimlerChrysler standard 5431.

For the lacquer adhesion, so-called coefficient of friction sheets are produced from the moulding compositions according to the invention at a composition temperature of 280° C. and a tool temperature of 60° C., a shear friction being applied during the mould-removal process. The coefficient of friction sheets are round sheets according to the following design. After the tool has been filled, the die is rotated through 37° C. at a die pressure of 50 N/cm² in the edge region of the circle for a period of 15 s. The die is then removed from the surface. The coefficient of friction tool, which is used to produce coefficient of friction sheets, is described, for example, in PCT 02/03211.

After the injection moulding, the sheets were stored at room temperature for about one week and then tempered at 80° C. for 30 minutes and subsequently lacquered with the hydro-based lacquer of type 101894 (colour obsidian black, Wörwag, Stuttgart). The sheets are then dried at room temperature for about 5 minutes and then at about 70° C. for about 30 minutes. The dry film thickness is approximately from 8 to 12 μm. The sheets are then lacquered with a solvent-containing clear lacquer of type 68945 (Wörwag, Stuttgart), and dried at room temperature for about 7 minutes and then at 80° C. for about 40 minutes. The dry film thickness is about 30 μm.

The lacquered sheets are stored at room temperature for about one week. A cross-cut was then made at four places in the ring (sketch hereinbelow) in which the shear friction was applied during removal of the moulding from the mould, and the steam jet test according to DBL standard 5431 was carried out. A total of 12 tests on 4 sheets from a batch were carried out per test.

The lacquer adhesion was evaluated in accordance with DBL 5431:

0=no defects, acceptable

1=detachment to 2 mm², acceptable

2=detachment 0.5 mm per side, acceptable

3=flaking over areas up to 40 mm² , not acceptable

4=flaking over large areas up to 250 mm², not acceptable

5=flaking over large areas of jet size >250 mm², not acceptable

As will be seen from Table 1, moulding compositions according to the invention, which contain both component A, for example polybutylene terephthalate, and component B, for example polyethylene terephthalate (Examples 1, 2 and 3), exhibit a lower failure quota and better evaluation in the steam jet test according DBL 5431 and accordingly better lacquer adhesion of the hydro lacquers than do the comparison examples, in which only component A or component B was used.

The mechanical properties, the dimensional stability under heat and the viscosity remain virtually unaffected and meet the demands for the moulding compositions in every case.

The composition and properties of the thermoplastic moulding compositions according to the invention are shown in Table 1.

TABLE 1

| | | b | c | d | e | f |
|---|---|---|---|---|---|---|
| | | Examples | | | | |
| | 476 | Comp. 1 | Ex. 1 | Ex. 2 | Ex. 3 | Comp. 2 |
| Component A, | [%] | 41.8 | 26.8 | 21.8 | 11.8 | — |
| polybutylene | | | | | | |
| terephthalate | | | | | | |
| Component B, | [%] | — | 15.0 | 20.0 | 30.0 | 41.8 |
| polyethylene | | | | | | |
| terephthalate | | | | | | |
| Component C, | [%] | 45.0 | 45.0 | 45.0 | 45.0 | 45.0 |
| polycarbonate | | | | | | |
| Component D, | [%] | 12.0 | 12.0 | 12.0 | 12.0 | 12.0 |
| ABS rubber | | | | | | |
| Additives | [%] | 1.2 | 1.2 | 1.2 | 1.2 | 1.2 |
| Vicat B | [° C.] | 129 | 131 | 130 | 130 | 138 |
| Izod impact | [kJ/m²] | n.b. | n.b. | n.b. | n.b. | n.b. |
| strength −50° C. | | | | | | |
| Izod notched | [kJ/m²] | 52 | 51 | 49 | 47 | 31 |
| impact | | | | | | |
| strength −20° C. | | | | | | |
| Tensile modulus | [MPa] | 2095 | 2130 | 2106 | 2108 | 2131 |
| Ultimate | [%] | 144 | 142 | 150 | 124 | 129 |
| elongation | | | | | | |
| Melt viscosity | [Pas] | 384 | 375 | 382 | 380 | 245 |
| (280° C./1000 s⁻¹) | | | | | | |
| Individual | | 9 × “0” | 11 × “0” | 12 × “0” | 12 × “0” | 6 × “0” |
| evaluation in | | 2 × “4.5” | 1 × “5” | | | 3 × “0.5” |
| the HDW test | | 1 × “5” | | | | 1 × “2” |
| | | | | | | 1 × “2.5” |
| | | | | | | 1 × “4” |
| Failure quota | [%] | 25 | 8 | 0 | 0 | 25 |
| in the HDW test | | | | | | |

n.b. = not broken

1-5. (canceled)

6. A thermoplastically molded article comprising
A) 4 to 80 parts by weight (pbw) of a first polyalkylene terephthalate,
B) 4 to 80 pbw of a second polyalkylene terephthalate having an alkylene chain length different from said first polyalkylene terephthalate,
C) 10 to 90 pbw of aromatic polycarbonate,
D) 1 to 30 pbw of at least one member selected from the group consisting of elastomeric polymer and graft copolymer,
E) 0.1 to 20 pbw of at least one member selected from the group consisting of conventional additive and processing aid, wherein the total pbw of (A) through (E) equals 100 pbw, and optionally
F) 0 to 60 pbw of a particulate mineral filler, said article lacquered with a water-based lacquers.

7. The article of claim 6 wherein said A is present in an amount of 10 to 60 pbw, B is present in an amount of 6 to 60 pbw, C is present in an amount of 20 to 80 pbw, D is present in an amount of 3 to 25 pbw and E is present in an amount 0.15 to 15 pbw.

8. The article of claim 6 wherein said A is present in an amount of 12 to 40 pbw, B is present in an amount of 8 to 40 pbw, C is present in an amount of 25 to 60 pbw, D is present in an amount of 6 to 20 pbw and E is present in an amount of 0.2 to 10 pbw.

9. The article of claim 6 wherein A is polybutylene terephthalate, B is polyethylene terephthalate and D is an elastomeric polymer.

10. The article of claim 6 wherein A is polybutylene terephthalate, B is polyethylene terephthalate and D is a graft copolymer.

11. The article of claim 6 wherein the conventional additive is a member selected from the group consisting of stabilizer, antistatic, flow aid, mold-release agent, fireproofing additive, emulsifier, nucleating agent, plasticizer, lubricant, additive that lower the pH value, additive for increasing conductivity, coloring and pigment.
